(19) United States
(12) Patent Application Publication
(10) Pub. No.: US 2026/0103234 A1
(43) Pub. Date: Apr. 16, 2026

(54) CONTROL DEVICE, MOTOR DEVICE, ELECTRIC POWER STEERING DEVICE, CONTROL METHOD, AND PROGRAM

(71) Applicant: NIDEC CORPORATION, Kyoto (JP)

(72) Inventors: Shuji ENDO, Kyoto (JP); Sohei MIYAKE, Kyoto (JP)

(21) Appl. No.: 19/352,660

(22) Filed: Oct. 8, 2025

Related U.S. Application Data
(60) Provisional application No. 63/705,666, filed on Oct. 10, 2024.

(30) Foreign Application Priority Data
Jan. 17, 2025 (JP) 2025-007038

(51) Int. Cl. B62D 5/04; B62D 6/00

(52) U.S. Cl. CPC B62D 5/0463; B62D 6/00

(57) ABSTRACT

A model following controller is configured or programmed such that a transfer function of a control target is constrained to a transfer function of a nominal model in a frequency band in which a complementary sensitivity gain, which is a gain in a gain characteristic of a complementary sensitivity function with respect to a modeling error between the control target and the nominal model, is 1 or substantially 1. An input torque in a state where a first correction torque and a second correction torque are subtracted is input to the control target. A gain of a transfer function of a corrector in a first frequency band equal to or lower than a predetermined frequency is larger than a gain of the transfer function of the corrector in a second frequency band higher than the predetermined frequency.

### CROSS-REFERENCE TO RELATED APPLICATIONS

The present application is a non-provisional of U.S. Patent Application No. 63/705,666, filed on Oct. 10, 2024, and claims priority under 35 U.S.C. § 119 to Japanese Patent Application No. 2025-007038, filed on Jan. 17, 2025, the entire contents of which are incorporated herein by reference.

### 1. FIELD OF THE INVENTION

The present disclosure relates to control devices, motor devices, electric power steering devices, control methods, and non-transitory computer-readable media including programs.

### 2. BACKGROUND

An electric power steering system mounted on a vehicle is known.

In the electric power steering system as described above, for example, it is conceivable to suppress disturbance transmitted to a steering person who steers the vehicle by using model following control. However, in this case, there is a problem that transmission of a torque such as a torque transmitted from the road surface on which the vehicle travels to the steering person, which is preferably transmitted to the steering person in order for the steering person to suitably obtain the steering feeling, is suppressed, and the steering feeling felt by the steering person decreases.

### SUMMARY

A control device according to an example embodiment of the present disclosure controls, as a control target, a portion including a motor in an electric power steering device to be mounted on a vehicle, the electric power steering device including an input shaft to which a steering wheel to be steered by a steering person is connected, an output shaft connected to the input shaft via a torsion bar, and the motor connected to the output shaft. The control device includes an assist controller configured or programmed to generate an input torque to be input to the control target based on a torsion bar torque generated in the torsion bar, a model following controller configured or programmed to generate a first correction torque to correct the input torque based on a nominal model based on a configuration of the control target, and a corrector configured to receive the torsion bar torque as an input and output a second correction torque to correct the input torque. The model following controller is configured or programmed such that a transfer function of the control target is constrained to a transfer function of the nominal model in a frequency band in which a complementary sensitivity gain, which is a gain in a gain characteristic of a complementary sensitivity function with respect to a modeling error between the control target and the nominal model, is 1 or substantially 1. The input torque in a state where the first correction torque and the second correction torque are subtracted is input to the control target. A gain of a transfer function of the corrector in a first frequency band that is equal to or lower than a predetermined frequency is larger than a gain of a transfer function of the corrector in a second frequency band higher than the predetermined frequency.

A motor device according to an example embodiment of the present disclosure includes the control device and the motor.

An electric power steering device according to an example embodiment of the present disclosure includes the motor device according to another example embodiment of the present disclosure, and a steering assembly including the input shaft, the output shaft, and the torsion bar.

A control method according to an example embodiment of the present disclosure is a method of controlling, as a control target, a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft, the control method includes generating an input torque to be input to the control target based on a torsion bar torque generated in the torsion bar, executing a model following control to generate a first correction torque to correct the input torque based on a nominal model based on a configuration of the control target, constraining a transfer function of the control target to a transfer function of the nominal model in a frequency band in which a complementary sensitivity gain is 1 or substantially 1 by the model following control, the complementary sensitivity gain being a gain in a gain characteristic of a complementary sensitivity function with respect to a modeling error between the control target and the nominal model, receiving the torsion bar torque as an input and outputting a second correction torque to correct the input torque, inputting, to the control target, the input torque in a state in which the first correction torque and the second correction torque are subtracted, and increasing a gain of a transfer function from the torsion bar torque to the second correction torque in a first frequency band that is equal to or lower than a predetermined frequency to be larger than a gain of the transfer function from the torsion bar torque to the second correction torque in a second frequency band that is higher than the predetermined frequency.

A non-transitory computer-readable medium including a computer program according to an example embodiment of the present disclosure causes a computer to execute the control method described above.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram schematically illustrating an electric power steering device according to an example embodiment of the present disclosure.

FIG. 2 is a block diagram illustrating a configuration of a control device according to an example embodiment of the present disclosure.

FIG. 3 is a functional block diagram illustrating functions of a processor in the control device according to an example embodiment of the present disclosure.

FIG. 4 is a graph illustrating a gain characteristic of a complementary sensitivity function and a gain characteristic of a reciprocal of a modeling error between a transfer function of a control target and a transfer function of a nominal model according to an example embodiment of the present disclosure.

FIG. 5 is a graph illustrating an example of a relationship between a steering angle and a self-aligning torque.

FIG. 6 is a graph illustrating an example of a gain characteristic of a transfer function of a corrector according to an example embodiment of the present disclosure.

FIG. 7 is a block diagram simply illustrating a control device according to an example embodiment of the present disclosure.

FIG. 8 is a graph illustrating an example of a gain characteristic of a transfer function from a steering torque to a control target according to an example embodiment of the present disclosure.

### DETAILED DESCRIPTION

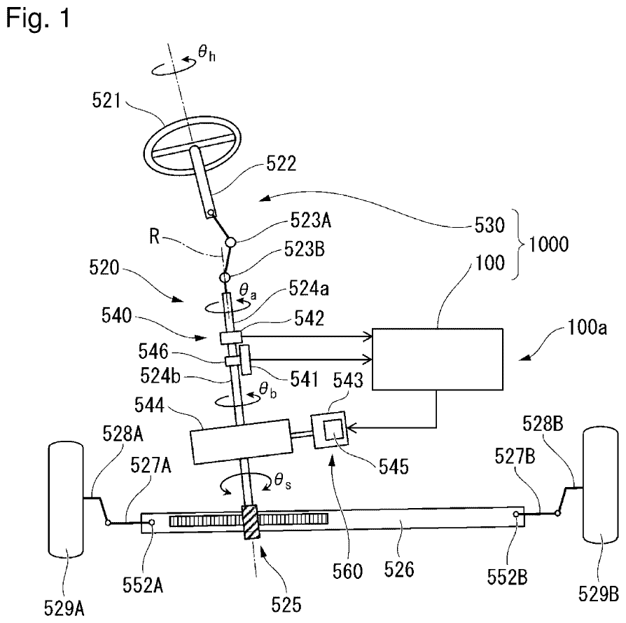

An electric power steering device 1000 of the present example embodiment illustrated in FIG. 1 is mounted on a vehicle. As illustrated in FIG. 1, the electric power steering device 1000 includes a steering assembly 530 and a control device 100. The steering assembly 530 includes a steering assembly 520 and an auxiliary mechanism unit 540. The electric power steering device 1000 controls the auxiliary mechanism unit 540 by the control device 100 to generate an auxiliary torque that assists a steering torque Tₕ generated in the steering assembly 520 when a driver who drives the vehicle steers a steering wheel 521. The auxiliary torque reduces the burden of the driver's operation when the driver operates the steering wheel 521. The driver of the vehicle is a steering person who steers the steering wheel 521 of the vehicle.

The steering assembly 520 includes the steering wheel 521, a steering shaft 522, universal joints 523A and 523B, an input shaft 524a, an output shaft 524b, a rack and pinion mechanism 525, a rack shaft 526, right and left ball joints 552A and 552B, tie rods 527A and 527B, knuckles 528A and 528B, and right and left tires 529A and 529B. That is, the steering assembly 530 includes the steering wheel 521, the steering shaft 522, the universal joints 523A and 523B, the input shaft 524a, the output shaft 524b, the rack and pinion mechanism 525, the rack shaft 526, the right and left ball joints 552A and 552B, the tie rods 527A and 527B, the knuckles 528A and 528B, and the right and left tires 529A and 529B.

The steering shaft 522 is a shaft extending from the steering wheel 521 steered by a steering person. One end portion of the input shaft 524a is connected to an end portion of the steering shaft 522 on a side opposite to a side connected to the steering wheel 521 via the universal joints 523A and 523B. As a result, the steering wheel 521 is connected to the input shaft 524a via the universal joints 523A and 523B and the steering shaft 522. The output shaft 524b is connected to the input shaft 524a via a torsion bar 546 described later. More specifically, one end portion of the output shaft 524b is connected to another end portion of the input shaft 524a via the torsion bar 546. The other end portion of the output shaft 524b is connected to the rack shaft 526 via the rack and pinion mechanism 525.

The input shaft 524a and the output shaft 524b are coaxially arranged. The input shaft 524a and the output shaft 524b are rotatable about the same central axis. The input shaft 524a and the output shaft 524b are relatively rotatable with respect to each other in a range in which the torsion bar 546 described later can be twisted.

The auxiliary mechanism unit 540 includes a steering torque sensor 541, a steering angle sensor 542, a motor 543, a deceleration mechanism 544, an inverter 545, and the torsion bar 546. That is, the steering assembly 530 includes the steering torque sensor 541, the steering angle sensor 542, the motor 543, the deceleration mechanism 544, the inverter 545, and the torsion bar 546. The torsion bar 546 connects the input shaft 524a and the output shaft 524b. The torsion bar 546 is arranged coaxially with the input shaft 524a and the output shaft 524b. In the description below, a virtual axis passing through a common central axis of the input shaft 524a, the output shaft 524b, and the torsion bar 546 is referred to as a rotation axis R. The torsion bar 546 can be twisted around the rotation axis R.

The steering torque sensor 541 detects the steering torque Tₕ in the steering assembly 520 by detecting the amount of torsion around the rotation axis R of the torsion bar 546. The steering torque Tₕ is a torsion bar torque generated in the torsion bar 546, and is torsional moment around the rotation axis R. The steering angle sensor 542 can detect a rotation angle θₐ around the rotation axis R of the input shaft 524a. The rotation angle θₐ of the input shaft 524a is equal to a steering angle θₕ of the steering wheel 521. That is, the steering angle sensor 542 can detect the steering angle θₕ of the steering wheel 521 by detecting the rotation angle θₐ of the input shaft 524a. A rotation angle θ_{b} of the output shaft 524b can be detected based on the steering torque sensor 541 and the steering angle sensor 542. The rotation angle θ_{b} of the output shaft 524b is a steering angle θₛ.

The inverter 545 converts DC power into three-phase AC power having U-phase, V-phase, and W-phase pseudo sine waves in accordance with a motor driving signal input from the control device 100, and supplies the power to the motor 543. The motor 543 is connected to the output shaft 524b via the deceleration mechanism 544. The three-phase AC power is supplied from the inverter 545 to the motor 543. The motor 543 is, for example, an interior permanent magnet synchronous motor (IPMSM), a surface mounted permanent magnet synchronous motor (SPMSM), a switched reluctance motor (SRM), or the like. When the three-phase AC power is supplied from the inverter 545, the motor 543 generates an auxiliary torque according to the steering torque Tₕ. The motor 543 transmits the generated auxiliary torque to the output shaft 524b via the deceleration mechanism 544.

The control device 100 controls a portion including at least the motor 543 of the steering assembly 530 mounted on the vehicle, as the control target 560. In the present example embodiment, the control target 560 includes the steering assembly 520, the torsion bar 546, the motor 543, and the deceleration mechanism 544. Since the control target 560 includes the input shaft 524a and the output shaft 524b that can rotate relative to each other via the torsion bar 546, the motion of the control target 560 cannot be described only by a simple equation of motion of the one-inertia system. The control target 560 changes between the one-inertia system and the two-inertia system depending on the strength with which the steering person grips the steering wheel 521. The stronger the steering person grips the steering wheel 521, the closer the control target 560 is to the one-inertia system. The weaker the steering person grips the steering wheel 521, the closer the control target 560 is to the two-inertia system. As described above, the control target 560 includes the two-inertia system.

The control device 100 is electrically connected to the inverter 545. The control device 100 generates a motor driving signal based on the detection signals detected by the steering torque sensor 541, the steering angle sensor 542, a vehicle speed sensor 300 mounted on a vehicle, and the like, and outputs the motor driving signals to the inverter 545. The control device 100 controls the control target 560 by controlling the rotation of the motor 543 via the inverter 545. More specifically, the control device 100 controls the switching operation of a plurality of switching elements included in the inverter 545. Specifically, the control device 100 generates a control signal for controlling the switching operation of each switching element and outputs the control signal to the inverter 545. Each switching element is, for example, a metal-oxide-semiconductor field-effect transistor (MOSFET). In the description below, a control signal for controlling the switching operation of each switching element is referred to as a “gate control signal”.

The control device 100 generates a torque command value based on the steering torque Tₕ and the like, and controls the torque of the motor 543 and the rotation speed of the motor 543 by means of, for example, vector control. The vector control is a method in which current flowing through the motor 543 is separated into a current component that contributes to generation of a torque and a current component that contributes to generation of a magnetic flux, and the current components orthogonal to each other are independently controlled. The control device 100 may perform not only the vector control but also another piece of closed-loop control. A rotational speed of the motor 543 is expressed by, for example, a rotational speed [revolutions per minute (rpm)] at which a rotor rotates in one minute, a rotational speed [revolutions per second (rps)] at which a rotor rotates in one second, or the like.

Note that a value of the steering torque Tₕ may be directly input to the control device 100 from the steering torque sensor 541, or the control device 100 may calculate a value of the steering torque Tₕ from an output value of the steering torque sensor 541. A value of the steering angle θₕ of the steering wheel 521 may be directly input to the control device 100 from the steering angle sensor 542, or the control device 100 may calculate a value of the steering angle θₕ from an output value of the steering angle sensor 542.

In the present example embodiment, the electric power steering device 1000 includes a motor device 100a. The motor device 100a includes the control device 100, the motor 543, and the inverter 545. The motor device 100a can be manufactured and sold independently of a portion other than the motor device 100a of the electric power steering device 1000. In addition, the control device 100 can be manufactured and sold as a control device for controlling the electric power steering device 1000 independently of a portion other than the control device 100 of the motor device 100a.

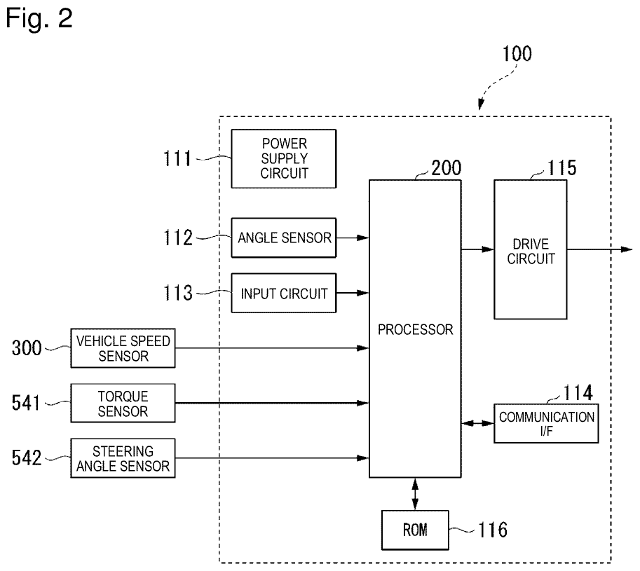

FIG. 2 illustrates a typical example of the configuration of the control device 100 according to the present example embodiment. The control device 100 includes a power supply circuit 111, an angle sensor 112, an input circuit 113, a communication I/F 114, a driving circuit 115, a ROM 116, and a processor 200, for example. The control device 100 may be realized as a printed circuit board (PCB) on which these electronic components are mounted.

The vehicle speed sensor 300, the steering torque sensor 541, and the steering angle sensor 542, mounted on the vehicle, are connected to the processor 200 such that signals can be input to the processor 200. The processor 200 receives the vehicle speed from the vehicle speed sensor 300. The processor 200 receives the steering torque Tₕ from the steering torque sensor 541. The processor 200 receives the steering angle θₕ from the steering angle sensor 542.

The processor 200 is a semiconductor integrated circuit, and is also referred to as a central processing unit (CPU) or a microprocessor. The processor 200 sequentially executes computer programs which are stored in the ROM 116 and describe commands for controlling motor driving, and realizes desired processing. In addition to the processor 200 or instead of the processor 200, the control device 100 may include a field programmable gate array (FPGA) equipped with a CPU, a graphics processing unit (GPU), an application specific integrated circuit (ASIC), an application specific standard product (ASSP), or a combination of two or more circuits selected from these circuits. The processor 200 sets a current command value according to the actual current value, the rotation angle of the rotor of the motor 543, and the like, generates a pulse width modulation (PWM) signal, and outputs the PWM signal to the driving circuit 115.

The power supply circuit 111 is connected to an external power supply (not illustrated). The power supply circuit 111 generates DC voltage necessary for each unit of the control device 100. The DC voltage generated in the power supply circuit 111 is, for example, 3 V or 5 V.

The angle sensor 112 detects a rotation angle of the rotor in the motor 543, and outputs the rotation angle to the processor 200. The angle sensor 112 may be a resolver, a Hall element such as a Hall IC, or an MR sensor having a magnetoresistive element. The processor 200 can calculate an angular velocity ω [rad/s] of the motor 543 based on an electrical angle of the motor 543 obtained based on the angle sensor 112. Note that the control device 100 may include, instead of the angle sensor 112, a speed sensor capable of detecting a rotational angular velocity of the motor 543 and an acceleration sensor capable of detecting a rotational angular acceleration of the motor 543.

A motor current value detected by a current sensor (not illustrated) is input to the input circuit 113. In the description below, a motor current value detected by a current sensor (not illustrated) is referred to as an “actual current value”. The input circuit 113 converts the level of an input actual current value into an input level of the processor 200 as necessary, and outputs the actual current value to the processor 200. A typical example of the input circuit 113 is an analog-digital conversion circuit.

The communication I/F 114 is an input and output interface for transmitting and receiving data in conformity with an in-vehicle controller area network (CAN), for example.

The driving circuit 115 is typically a gate driver or a pre-driver. The driving circuit 115 generates a gate control signal in accordance with a PWM signal, and gives the gate control signal to gates of a plurality of switching elements included in the inverter 545. For example, when the motor 543 to be driven is a motor that can be driven at a low voltage, the driving circuit 115 as a gate driver is not necessarily required in some cases. In that case, the function of the gate driver in the driving circuit 115 may be implemented in the processor 200.

The ROM 116 is electrically connected to the processor 200. The ROM 116 is a writable memory, a rewritable memory, or a read-only memory, for example. Examples of the writable memory include a programmable read only memory (PROM). Examples of the rewritable memory include a flash memory, an electrically erasable programmable read only memory (EEPROM), and the like. The ROM 116 stores therein a control program including commands for causing the processor 200 to control motor driving. For example, the control program stored in the ROM 116 is once developed in a RAM (not illustrated) at the time of booting.

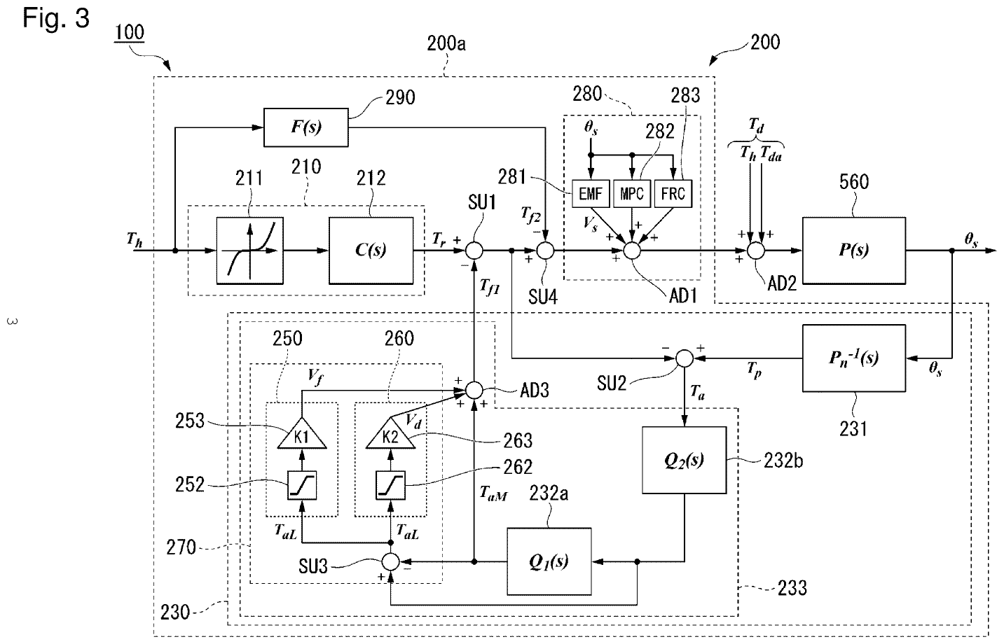

FIG. 3 illustrates an example of functional blocks of the processor 200 according to the present example embodiment. The processor 200, which is a computer, sequentially executes processing or tasks necessary for controlling the motor 543 using each functional block. Each functional block of the processor 200 illustrated in FIG. 3 may be implemented in the processor 200 as software such as firmware, may be implemented in the processor 200 as hardware, or may be implemented in the processor 200 as software and hardware. The processing of each functional block in the processor 200 is typically described in a computer program in units of software modules and stored in the ROM 116. However, in a case where an FPGA or the like is used, all or a part of the functional blocks may be implemented as a hardware accelerator. A method of controlling the control target 560 according to the present example embodiment is executed by the processor 200, which is a computer, executing a program stored in the control device 100. That is, the program of the present example embodiment stored in the control device 100 causes the processor 200, which is a computer, to execute the method of controlling the control target 560 of the present example embodiment.

The processor 200 includes a controller 200a. The controller 200a includes an assist controller 210, a model following controller 230, a state feedback unit 280, a corrector 290, and subtractors SU1 and SU4. That is, the control device 100 includes the assist controller 210, the model following controller 230, the state feedback unit 280, the corrector 290, and the subtractors SU1 and SU4. In other words, functions corresponding to the assist controller 210, the model following controller 230, the state feedback unit 280, the corrector 290, and the subtractors SU1 and SU4, respectively, are implemented in the processor 200 of the control device 100.

The steering torque Tₕ detected by the steering torque sensor 541 is input to the assist controller 210. The assist controller 210 generates the input torque Tᵣ to be input to the control target 560 based on the steering torque Tₕ, that is, the torsion bar torque generated in the torsion bar 546. In other words, the method of controlling the control target 560 includes generating the input torque Tᵣ to be input to the control target 560 based on the steering torque Tₕ. The input torque Tᵣ is a target torque of the motor 543 and is a torque command value. The assist controller 210 generates the input torque Tᵣ and controls the torque of the motor 543 to thereby control the reaction force transmitted from the steering wheel 521 to the steering person. The assist controller 210 generates the input torque Tᵣ by applying phase compensation to the steering torque Tₕ when the steering frequency or the steering speed is within a predetermined range. The steering frequency is a frequency of the steering angle that changes based on the operation of the steering wheel 521 by the steering person. The steering speed is a speed of the steering angle that changes based on the operation of the steering wheel 521 by the steering person. The assist controller 210 illustrated in FIG. 3 includes a base assist calculation unit 211 and a phase compensator 212.

The base assist calculation unit 211 acquires the steering torque Tₕ and the vehicle speed. The base assist calculation unit 211 generates a base assist torque based on the steering torque Tₕ and the vehicle speed. For example, the base assist calculation unit 211 includes a look-up table (LUT) in which a relationship among the steering torque Tₕ, the vehicle speed, and the base assist torque is defined. The base assist calculation unit 211 can determine the base assist torque having a correspondence relationship based on the steering torque Tₕ and the vehicle speed with reference to the look-up table. The base assist calculation unit 211 can determine a base assist gain based on the inclination defined by a ratio of a change amount of the base assist torque to a fluctuation amount of the steering torque Tₕ.

The phase compensator 212 in the present example embodiment adjusts the base assist gain within a possible range of the steering frequency when the steering person operates the steering wheel 521, and compensates for the rigidity of the torsion bar 546. The range that a steering frequency can take is, for example, 5 Hz or less. The phase compensator 212 may apply, for example, first-order phase compensation to the steering torque Tₕ, that is, the torsion bar torque, when the steering frequency is 5 Hz or less. The first-order phase compensation is expressed by, for example, a transfer function of Expression (1).

$$\begin{matrix}Expression 1 & \\ C ( s ) = \frac{\frac{1}{2 π {f}_{1}} s + 1}{\frac{1}{2 π {f}_{2}} s + 1} & ( 1 )\end{matrix}$$

In Expression (1), s represents a Laplace transformer, f₁ represents a frequency (Hz) at the zero point of the transfer function, and f₂ represents a frequency (Hz) for determining the pole of the transfer function. A graph in which the gain or loop gain is set as a vertical axis and the logarithm of the frequency is set as a horizontal axis is referred to as a gain diagram. In the gain diagram, the zero point means the intersection of the gain curve and the horizontal axis indicating 0 dB, and the pole means the maximum point of the gain curve. For example, by setting the pole frequency to be higher than the zero point frequency, a phase lead compensation can be applied. The larger the interval between the frequency of the pole and the frequency of the zero point, the larger the phase advance amount.

The phase compensator 212 generates the input torque Tᵣ based on the base assist torque and the base assist gain output from the base assist calculation unit 211. For example, the phase compensator 212 may be a stabilization compensator and apply stability phase compensation to the base assist torque. The phase compensator 212 may have a second-order or higher transfer function whose frequency characteristic is variable according to the base assist gain. The second-order or higher transfer function is expressed using a responsiveness parameter and a damping parameter. The second-order or higher transfer function can be expressed by, for example, Expression (2). By setting the order number of the transfer function to two, damping can be given to the characteristic of the transfer function. A phase characteristic can be adjusted by changing the damping.

$$\begin{matrix}Expression 2 & \\ C ( s ) = \frac{{s}^{2} + 2 {ζ}_{1} {ω}_{1} s + {ω}_{1}^{2}}{{s}^{2} + 2 {ζ}_{2} {ω}_{2} s + {ω}_{2}^{2}} ( \frac{{ω}_{2}^{2}}{{ω}_{1}^{2}} ) & ( 2 )\end{matrix}$$

In Expression (2), s represents a Laplace transformer, ω₁ represents a frequency at the zero point of the transfer function, ω₂ represents a frequency of a pole of the transfer function, ζ₁ represents a damping ratio of the zero point, and ζ₂ represents a damping ratio of the pole. The pole frequency ω₂ is lower than the zero point frequency ω₁.

The model following controller 230 generates a first correction torque T_{f1} to correct the input torque Tᵣ based on a nominal model based on the configuration of the control target 560. In the present example embodiment, the first correction torque T_{f1} is a feedback torque fed back to the input torque Tᵣ. The nominal model is an internal model used as a model that constrains the control target 560 when controlling the control target 560. The nominal model will be described in detail later. The model following controller 230 is a controller configured to perform model following control. The method of controlling the control target 560 includes executing the model following control to generate the first correction torque T_{f1} to correct the input torque Tᵣ based on the nominal model based on the configuration of the control target 560. A specific configuration of the model following controller 230 will be described in detail later.

The subtractor SU1 subtracts the first correction torque T_{f1} output from the model following controller 230, from the input torque Tᵣ. The output from the subtractor SU1 is input to the subtractor SU4 and the model following controller 230. The subtractor SU4 outputs a value obtained by subtracting the output from the corrector 290 from the output from the subtractor SU1, to an adder AD1. The adder AD1 outputs a value obtained by adding an output from the state feedback unit 280 to the output from the subtractor SU4, to an adder AD2. The adder AD2 outputs a value obtained by adding a disturbance torque T_{d} to the output from the adder AD1, to the control target 560.

The disturbance torque T_{d} is a difference between the actual output torque of the motor 543 and the ideal output torque of the motor 543. The disturbance torque T_{d} includes a disturbance torque externally applied to the control target 560. The disturbance torque T_{d} includes, for example, an extra torque generated by friction and backlash due to mechanical elements such as the motor 543 and the deceleration mechanism 544, a torque ripple generated in the motor 543, a self-aligning torque T_{SAT}, a disturbance torque that may be generated when traveling on an unpaved rattling road, a gravel road, or the like, and the steering torque Tₕ. A torque T_{da} illustrated in FIG. 3 is a torque excluding the steering torque Tₕ in the disturbance torque T_{d}. That is, the disturbance torque T_{d} is a torque obtained by adding the torque T_{da} and the steering torque Tₕ. The torque T_{d}a includes the self-aligning torque T_{SAT}.

In the present example embodiment, the model following controller 230 generates the first correction torque T_{f1} based on the steering angle θₛ, and feeds back the first correction torque T_{f1} to the input torque Tᵣ. The model following controller 230 includes an inverse nominal model 231, a first filter 232a, a second filter 232b, an assist adjustment unit 270, a subtractor SU2, and an adder AD3. In the present example embodiment, the first filter 232a is a high-pass filter. The first filter 232a has a first cutoff frequency Cf1. The first cutoff frequency Cf1 is, for example, 2 Hz or higher and 10 Hz or lower. In the present example embodiment, the first cutoff frequency Cf1 is higher than 5 Hz and lower than 10 Hz.

In the present example embodiment, the second filter 232b is a low-pass filter. The second filter 232b has a second cutoff frequency Cf2 higher than the first cutoff frequency Cf1. The second cutoff frequency Cf2 is, for example, 3 Hz or higher and 50 Hz or lower. However, an upper limit of the second cutoff frequency Cf2 may be set in a range of about 140 Hz or higher and 200 Hz or lower. The order of the second filter 232b is third order or more. The second filter 232b may include, for example, a plurality of low-pass filters. The first filter 232a and the second filter 232b are coupled in series.

The model following controller 230 is configured such that a transfer function P(s) of the control target 560 is constrained to a transfer function Pₙ(s) of the nominal model in a frequency band in which a complementary sensitivity gain GT that is a gain in the gain characteristic of a complementary sensitivity function T(s) with respect to a modeling error between the control target 560 and the nominal model is substantially 1. In other words, the control method of the present example embodiment includes constraining the transfer function P(s) of the control target 560 to the transfer function Pₙ(s) of the nominal model in the frequency band in which the complementary sensitivity gain GT is substantially 1, by the model following control. “The complementary sensitivity gain GT is substantially 1” includes, for example, the case where the complementary sensitivity gain GT is 0.8 or more and 1.2 or less, in addition to the case where the complementary sensitivity gain GT is 1. The numerical range is, for example, a range in which a gain of a substantial disturbance reduction characteristic can be adjusted to 1 in consideration of positive efficiency and reverse efficiency of a worm gear in the case where the deceleration mechanism 544 connected to the motor 543 includes the worm gear. Since efficiency of the worm gear is about 0.8, it is necessary to adjust the gain by ±0.2 with respect to the target value 1.

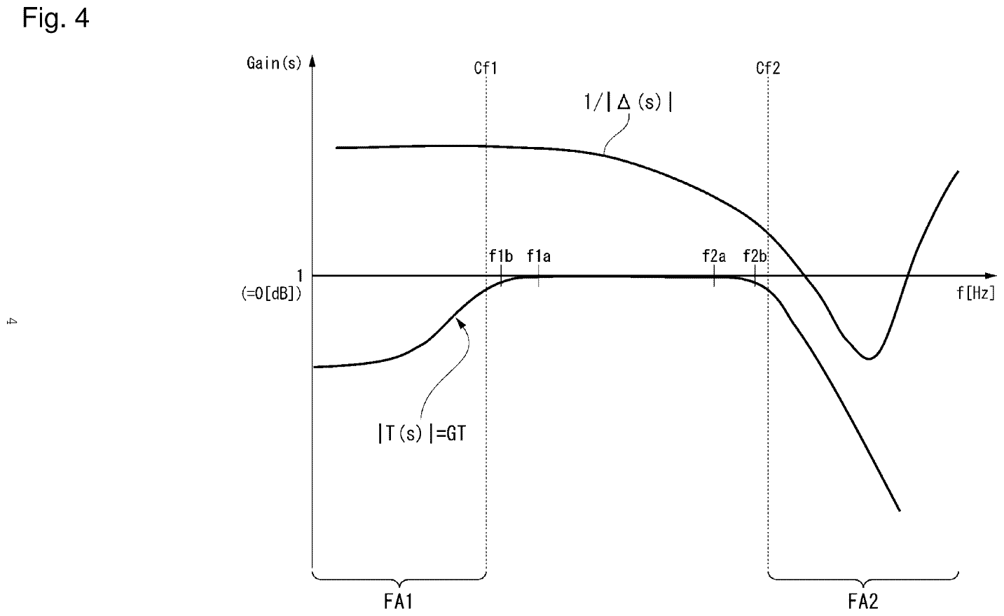

The complementary sensitivity function T(s) is a complementary sensitivity function of an inner loop including the model following controller 230. FIG. 4 illustrates the complementary sensitivity gain GT in the complementary sensitivity function T(s). The complementary sensitivity gain GT is a gain of the complementary sensitivity function T(s) as a transfer function, and is an absolute value of the complementary sensitivity function T(s). In the graph of FIG. 4, the horizontal axis represents the frequency f [Hz], and the vertical axis represents the complementary sensitivity gain GT. As illustrated in FIG. 4, in the complementary sensitivity function T(s), the gain is substantially 0 dB in at least a part of the frequency band where the frequency f is equal to or higher than the first cut-off frequency Cf1 and equal to or lower than the second cut-off frequency Cf2, that is, the complementary sensitivity gain GT in the transfer function is substantially 1. In the example of FIG. 4, the complementary sensitivity gain GT is 1 in a frequency band that is equal to or higher than the frequency f1a higher than the first cut-off frequency Cf1 and equal to or lower than the frequency f2a lower than the second cut-off frequency Cf2. The frequency f1a is lower than the frequency f2a. In the frequency band of the frequency f1a or higher and the frequency f2a or lower, the complementary sensitivity gain GT may be, for example, a value of 0.95 or larger and smaller than 1. The complementary sensitivity gain GT at the first cutoff frequency Cf1 is smaller than the complementary sensitivity gain GT at the frequency f1a. The complementary sensitivity gain GT at the second cutoff frequency Cf2 is smaller than the complementary sensitivity gain GT at the frequency f2a. In the present example embodiment, the frequency band in which the complementary sensitivity gain GT is substantially 1 is a frequency band of the frequency f1b or higher and the frequency f2b or lower. The frequency f1b is higher than the first cutoff frequency Cf1 and lower than the frequency f1a. The frequency f2b is lower than the second cutoff frequency Cf2 and higher than the frequency f2a. In the frequency band of the frequency f1b or higher and the frequency f2b or lower, the complementary sensitivity gain GT is, for example, 0.8 or larger and 1 or smaller. Note that, in the present description, “a transfer function of a control target is constrained to a transfer function of a nominal model” means that, for example, a control target is controlled such that a transfer function of the control target appears to be a transfer function of a nominal model apparently when an input and output relationship is viewed.

The transfer function P(s) of the control target 560 is a plant characteristic on which the model following control is performed. The transfer function P(s) of the control target 560 is expressed by, for example, Expression (3) below.

$$\begin{matrix}Expression 3 & \\ P ( s ) = \frac{1}{J {s}^{2} + Bs + {K}_{S A T}} & ( 3 )\end{matrix}$$

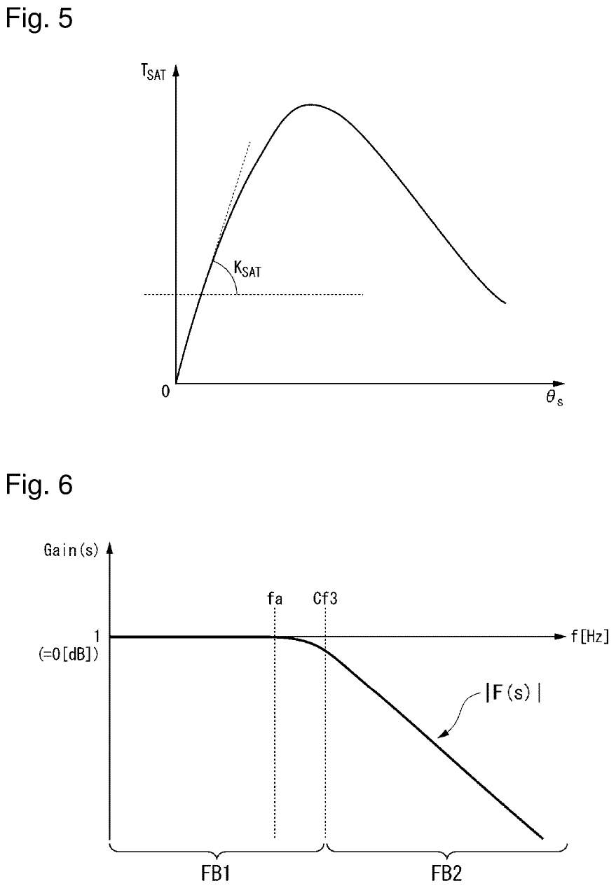

Here, s represents a Laplace transformer, J is a parameter representing the moment of inertia of the steering assembly 520, and B is a parameter representing a viscous friction coefficient of the steering assembly 520. K_{SAT} represents a self-aligning torque gain. The self-aligning torque gain K_{SAT} is an inclination of the self-aligning torque T_{SAT} generated in the tires 529A and 529B of the vehicle with respect to the steering angle θₛ. FIG. 5 illustrates an example of the relationship between the self-aligning torque T_{SAT} and the steering angle θ₃. In the graph of FIG. 5, the horizontal axis represents the steering angle θₛ, the vertical axis represents the self-aligning torque T_{SAT}, and the inclination of the self-aligning torque T_{SAT} with respect to the steering angle θₛ is the self-aligning torque gain K_{SAT}. The steering angle θₛ, the self-aligning torque T_{SAT}, and the self-aligning torque gain K_{SAT} satisfy the relationship of dT_{SAT}/dθₛ=K_{SAT}. As illustrated in FIG. 5, for example, the self-aligning torque T_{SAT} becomes larger as the steering angle θₛ becomes larger up to a certain degree of the steering angle θₛ, and becomes smaller as the steering angle θₛ becomes larger when the steering angle θₛ becomes a certain degree or more.

The inverse nominal model 231 is an inverse model of a predetermined nominal model used to constrain the control target 560. The transfer function Pₙ(s) of the nominal model is expressed by, for example, Expression (4) below. A transfer function Pₙ⁻¹(s) of the inverse nominal model 231 is expressed by, for example, Expression (5) below.

$$\begin{matrix}Expression 4 & \\ {P}_{n} ( s ) = \frac{1}{{J}_{n} {s}^{2} + {B}_{{n}^{S}}} & ( 4 )\end{matrix}$$

$$\begin{matrix}Expression 5 & \\ {P}_{n}^{- 1} ( s ) = {J}_{n} {s}^{2} + {B}_{n} s & ( 5 )\end{matrix}$$

In Expressions (4) and (5), s represents a Laplace transformer, Jₙ is a parameter representing the inertia moment of the nominal model, and Bₙ is a parameter representing the viscous friction coefficient of the nominal model. Note that the transfer function Pₙ(s) of the nominal model and the transfer function Pₙ⁻¹(s) of the inverse nominal model 231 are not limited to the examples illustrated in Expressions (4) and (5), and are not particularly limited.

As illustrated in FIG. 3, an output of the control target 560 is input to the inverse nominal model 231. In the present example embodiment, the steering angle θₛ is input to the inverse nominal model 231. That is, in the present example embodiment, the steering angle θₛ is input to the model following controller 230 as an output of the control target 560. The inverse nominal model 231 outputs the torque Tₚ based on Expression (5) described above and the input steering angle θ₃. That is, the model following controller 230 calculates the torque Tₚ using the nominal model based on the output of the control target 560. The torque Tₚ is equal to the value of the torque input to the nominal model when the output value of the nominal model is the same value as the output value of the control target 560.

The subtractor SU2 subtracts the output from the subtractor SU1 from the output of the inverse nominal model 231 to generate a differential torque Tₐ. The output from the subtractor SU1 is the input torque Tᵣ after the first correction torque T_{f1} is subtracted and before the second correction torque T_{f2} to be described later is subtracted. That is, the input torque Tᵣ after the first correction torque T_{f1} is subtracted and before the second correction torque T_{f2} is subtracted is input to the model following controller 230. In the present example embodiment, after the first correction torque T_{f1} is fed back, the subtractor SU2 subtracts, from the torque Tₚ, the input torque Tᵣ before a state compensation value Vₛ to be described later is fed back and before the second correction torque T_{f2} to be described later is subtracted, to generate the differential torque Tₐ. The differential torque Tₐ is, for example, an estimated value obtained by subtracting the second correction torque T_{f2} to be described later from the disturbance torque T_{d}. The differential torque Tₐ output from the subtractor SU2 is input to the second filter 232b and subjected to low-pass filter processing, and then input to the first filter 232a and subjected to high-pass filter processing. The differential torque Tₐ subjected to filter processing by the first filter 232a and the second filter 232b is input to the adder AD3. The differential torque Tₐ subjected to filter processing by the first filter 232a and the second filter 232b is in a state in which a frequency component lower than the first cutoff frequency Cf1 and a frequency component higher than the second cutoff frequency Cf2 are removed. That is, the differential torque Tₐ subjected to filter processing by the first filter 232a and the second filter 232b is a frequency component T_{aM} equal to or higher than the first cutoff frequency Cf1 and equal to or lower than the second cutoff frequency Cf2.

The assist adjustment unit 270 generates a compensation value for friction and disturbance and adjusts the differential torque Tₐ. In the present example embodiment, the assist adjustment unit 270 adjusts the frequency component T_{aM} in the differential torque Tₐ. The assist adjustment unit 270 is coupled in parallel to the first filter 232a. The assist adjustment unit 270 includes a friction compensation value calculation unit 250, a disturbance compensation value calculation unit 260, and a subtractor SU3.

The subtractor SU3 subtracts an output value from the first filter 232a, from an output value from the second filter 232b. Here, an output value from the second filter 232b is a value obtained by removing a frequency component higher than the second cutoff frequency Cf2 from the differential torque Tₐ. An output value from the first filter 232a is a value obtained by removing a frequency component higher than the second cutoff frequency Cf2 and a frequency component lower than the first cutoff frequency Cf1 from the differential torque Tₐ. Therefore, the value output from the subtractor SU3 is the frequency component T_{aL} lower than the first cutoff frequency Cf1 in the differential torque Tₐ. The output of the subtractor SU3 is input to the friction compensation value calculation unit 250 and the disturbance compensation value calculation unit 260. The frequency component T_{aL} includes a frictional force, the self-aligning torque T_{SAT}, the disturbance torque caused by backlash of the control target 560, a torque ripple generated in the control target 560, and the like.

The friction compensation value calculation unit 250 calculates the friction compensation value V_{f} that compensates at least a part of the frictional force generated in control target 560, based on the differential torque Tₐ. As described above, the value from the subtractor SU3 input to the friction compensation value calculation unit 250 is the frequency component T_{aL} lower than the first cutoff frequency Cf1 in the differential torque Tₐ. Therefore, in the present example embodiment, the friction compensation value calculation unit 250 calculates the friction compensation value V_{f} based on the component having a frequency lower than the first cutoff frequency Cf1 in the differential torque Tₐ.

The friction compensation value calculation unit 250 includes a limiter 252 and a gain adjuster 253. The limiter 252 limits the output value from the subtractor SU3. The limiter 252 clips the input value to the upper or lower threshold when the input value exceeds the upper or lower threshold. The gain adjuster 253 applies a gain K1 to the output value from the limiter 252. The friction compensation value calculation unit 250 calculates the friction compensation value V_{f} by applying the limit by the limiter 252 and the gain K1 to the component of the frequency lower than the first cutoff frequency Cf1 in the differential torque Tₐ. The threshold of the limiter 252 and the value of the gain K1 are determined in advance based on, for example, the frictional force actually generated in the control target 560.

The friction compensation value V_{f} output from the friction compensation value calculation unit 250 is a value that compensates for at least a part of the frictional force component included in the frequency component T_{aL} of the differential torque Tₐ. In general, since appropriate friction is required for the control target 560, the friction compensation value calculation unit 250 calculates a value smaller than the frictional force actually generated in the control target 560 as the friction compensation value V_{f}. This makes it possible to achieve highly accurate friction compensation while maintaining an appropriate frictional force on the control target 560. A target of friction compensation using the friction compensation value V_{f} is, for example, friction of the motor 543, friction of the deceleration mechanism 544, a difference between right and left in friction of the deceleration mechanism 544, and the like.

The vehicle equipped with the electric power steering device 1000 can travel according to a travel mode having an automatic driving mode and a manual driving mode. In this case, the gain K1 of the gain adjuster 253 may be switched according to the travel mode. The greater the gain K1 of the gain adjuster 253, the greater the degree of friction reduction. The gain K1 in the automatic driving mode is preferably larger than the gain K1 set in the manual driving mode. As a result, it is possible to apply optimum friction compensation to an automatic driving mode in which a reduction in friction is more required.

The disturbance compensation value calculation unit 260 calculates a disturbance compensation value V_{d} for compensating at least a part of the self-aligning torque T_{SAT} generated in the control target 560. In the present example embodiment, the disturbance compensation value V_{d} includes a compensation value for compensating at least a part of the frictional force generated in the control target 560, the disturbance torque caused by the backlash generated in the control target 560, and the torque ripple generated in the control target 560. The disturbance compensation value calculation unit 260 calculates the disturbance compensation value V_{d} based on the differential torque Tₐ that is a difference between the torque Tₚ output from the inverse nominal model 231 and the input torque Tᵣ. That is, the disturbance compensation value calculation unit 260 calculates the disturbance compensation value V_{d} based on the differential torque Tₐ that is a difference between the torque Tₚ calculated using the nominal model based on the output of the control target 560 and the input torque Tᵣ. As described above, the value from the subtractor SU3 input to the disturbance compensation value calculation unit 260 is a frequency component lower than the first cutoff frequency Cf1 in the differential torque Tₐ. Therefore, in the present example embodiment, the disturbance compensation value calculation unit 260 calculates the disturbance compensation value V_{d} based on a component having a frequency lower than the first cutoff frequency Cf1 in the differential torque Tₐ.

The disturbance compensation value calculation unit 260 includes a limiter 262 and a gain adjuster 263. The limiter 262 limits the output value from the subtractor SU3. The limiter 262 clips the input value to the upper or lower threshold when the input value exceeds the upper or lower threshold. The threshold of the limiter 262 is different from the threshold of the limiter 252, for example. The gain adjuster 263 applies a gain K2 to the output value from the limiter 262. The maximum value of the gain K2 of the gain adjuster 263 is determined under the condition that the transfer function P(s) of the control target 560 is constrained to the transfer function Pₙ(s) of the nominal model. The value of the gain K2 is different from the value of the gain K1, for example. The value of the gain K2 is, for example, about 0.1 or larger and 0.8 or smaller. The gain K2 of the gain adjuster 263 may be switched according to the travel mode of the vehicle.

The disturbance compensation value V_{d} is a value that compensates for at least a part of a self-aligning torque component included in the frequency component T_{aL} of the differential torque Tₐ. For example, the disturbance compensation value calculation unit 260 calculates a value corresponding to about half of the self-aligning torque T_{SAT} actually generated in the control target 560, as the disturbance compensation value V_{d}. The self-aligning torque T_{SAT} actually generated in the control target 560 is experimentally obtained in advance for each frequency, for example. The threshold of the limiter 262 of the disturbance compensation value calculation unit 260 and the value of the gain K2 are adjusted to values at which the disturbance compensation value V_{d} is calculated as a value about 0.1 times or more and 0.8 times or less the magnitude of the self-aligning torque T_{SAT} obtained in advance. The disturbance compensation value V_{d} calculated by the disturbance compensation value calculation unit 260 is a value different from the friction compensation value V_{f} calculated by the friction compensation value calculation unit 250.

Here, the frequency component T_{aL} of the differential torque Tₐ includes the frictional force generated in the control target 560, the self-aligning torque T_{SAT} generated in the control target 560, the disturbance torque caused by the backlash generated in the control target 560, and the torque ripple generated in the control target 560. For this reason, the friction compensation value V_{f} obtained by processing the frequency component T_{aL} by the limiter 252 and the gain adjuster 253 also includes a compensation value for compensating at least a part of the disturbance other than the frictional force, that is, the self-aligning torque T_{SAT} generated in the control target 560, the disturbance torque caused by backlash generated in the control target 560, and the torque ripple generated in the control target 560. In addition, the disturbance compensation value V_{d} obtained by processing the frequency component T_{aL} by the limiter 262 and the gain adjuster 263 also includes a compensation value for compensating at least a part of the disturbance other than the self-aligning torque T_{SAT}, that is, the frictional force generated in the control target 560, the disturbance torque caused by backlash generated in the control target 560, and the torque ripple generated in the control target 560.

In order to apply friction compensation and disturbance compensation performed in the assist adjustment unit 270 to the first correction torque T_{f1} used for model following control in the model following controller 230, it is necessary to pay attention to a stability condition of the model following control. This condition is that the gain in the gain characteristic of the transfer function of the assist adjustment unit 270 constrained to the characteristic considering stability does not exceed 1 according to the small gain theorem described later. This is derived from the design condition of the second filter 232b. In the present example embodiment, the subtractor SU3 is provided in the preceding stage of the limiters 252 and 262 so that the values of the gains K1 and K2 in the gain adjusters 253 and 263 are set to 1 at the maximum and the gain in the gain characteristic becomes 1 under this condition, and subtraction processing is applied. In other words, the assist adjustment unit 270 behaves as a low-pass filter having a transfer function of 1−Q₁(s). Q₁(s) is a transfer function of the first filter 232a that is a high-pass filter. The assist adjustment unit 270 performs low-pass filter processing having a transfer function of 1−Q₁(s) on the torque output from the second filter 232b, and adjusts the value applied with the processing in each of the friction compensation value calculation unit 250 and the disturbance compensation value calculation unit 260 and outputs the value.

The adder AD3 adds an output value from the assist adjustment unit 270 to an output value from the first filter 232a. That is, the adder AD3 adds the friction compensation value V_{f} and the disturbance compensation value V_{d} to the frequency component T_{aM}. The adder AD3 outputs the first correction torque T_{f1} calculated by adding the frequency component T_{aM}, the friction compensation value V_{f}, and the disturbance compensation value V_{d}. The first correction torque T_{f1} output from the adder AD3 is fed back to the input of the control target 560, that is, the input torque Tᵣ. As described above, in the present example embodiment, the model following controller 230 generates the first correction torque T_{f1} by adding the friction compensation value V_{f} and the disturbance compensation value V_{d} to the differential torque Tₐ from which a frequency component lower than the first cutoff frequency Cf1 is removed by the first filter 232a which is a high-pass filter, that is, the frequency component T_{aM}.

The state feedback unit 280 feeds back the state compensation value Vₛ to the input torque Tᵣ based on the output of the control target 560 so that the apparent transfer function of the control target 560 approaches the transfer function Pₙ(s) of the nominal model. The apparent transfer function of the control target 560 is, for example, a transfer function of one portion in a case where a portion located inside a feedback loop formed by the model following controller 230 is regarded as the one portion. Specifically, in the present example embodiment, the apparent transfer function of the control target 560 is a transfer function of the entire portion from the subtractor SU1 to the output of the control target 560, and is a transfer function of a portion combining the state feedback unit 280 and the control target 560. In the present example embodiment, the state feedback unit 280 feeds back the state compensation value Vₛ to the input torque Tᵣ after being corrected by the first correction torque T_{f1} and the second correction torque T_{f2} and before being input to the control target 560. More specifically, the state feedback unit 280 feeds back the state compensation value Vₛ to the value output from the subtractor SU4.

The state compensation value Vₛ includes a compensation value that compensates at least a part of the inertial force generated in the control target 560, the viscous force generated in the control target 560, and the frictional force generated in the control target 560. More specifically, the state compensation value Vₛ includes a compensation value that compensates at least a part of the inertial force generated in the motor 543, the viscous force generated in the motor 543, and the frictional force generated in the motor 543. In the present example embodiment, the state compensation value Vₛ is a compensation value including the inertial force generated in the motor 543, the viscous force generated in the motor 543, and the frictional force generated in the motor 543.

The state feedback unit 280 includes an inertia compensator 281, a viscosity compensator 282, and a friction compensator 283. The inertia compensator 281 calculates a compensation value for compensating at least a part of the inertial force generated in the motor 543 based on the steering angle θₛ. The viscosity compensator 282 calculates a compensation value for compensating at least a part of the viscous force generated in the motor 543 based on the steering angle θₛ. The friction compensator 283 calculates a compensation value for compensating at least a part of the frictional force generated in the motor 543 based on the steering angle θₛ. In the present example embodiment, the state compensation value Vₛ includes a compensation value calculated by the inertia compensator 281, a compensation value calculated by the viscosity compensator 282, and a compensation value calculated by the friction compensator 283. The compensation value calculated by the inertia compensator 281, the compensation value calculated by the viscosity compensator 282, and the compensation value calculated by the friction compensator 283 are output to the adder AD1 and added to the input torque Tᵣ having been corrected by the first correction torque T_{f1}.

The corrector 290 generates the second correction torque T_{f2} to correct the input torque Tᵣ based on the torsion bar torque, that is, the steering torque Tₕ. The steering torque Tₕ is input to the corrector 290. The corrector 290 outputs the second correction torque T_{f2} to the subtractor SU4. In the present example embodiment, the corrector 290 performs low-pass filter processing on the steering torque Tₕ to generate the second correction torque T_{f2}. The gain characteristic in the transfer function F(s) of the corrector 290 is expressed as, for example, the graph of FIG. 6. In the graph of FIG. 6, the horizontal axis represents the frequency f [Hz], and the vertical axis represents the gain of the transfer function F(s) of the corrector 290. In the low-pass filter processing performed by the corrector 290, the cutoff frequency is a third cutoff frequency Cf3. In the present example embodiment, the third cutoff frequency Cf3 corresponds to a “predetermined frequency”. The third cutoff frequency Cf3 is, for example, 5 Hz or higher and 15 Hz or lower. The value of the third cutoff frequency Cf3 is not particularly limited.

As illustrated in FIG. 6, a frequency band equal to or lower than the third cutoff frequency Cf3 is a first frequency band FB1. A frequency band higher than the third cutoff frequency Cf3 is a second frequency band FB2. The gain of the transfer function F(s) of the corrector 290 in the first frequency band FB1 is larger than the gain of the transfer function F(s) of the corrector 290 in the second frequency band FB2. The gain of the transfer function F(s) in the first frequency band FB1 is substantially 1. “The gain of the transfer function F(s) is substantially 1” includes the case where the gain of the transfer function F(s) is equal to or greater than the value of the gain of the transfer function F(s) at the third cutoff frequency Cf3, in addition to the case where the gain of the transfer function F(s) is 1. The gain of the transfer function F(s) at the third cutoff frequency Cf3 is smaller than 1. The gain of the transfer function F(s) at the third cutoff frequency Cf3 is, for example, 1/√2. The gain of the transfer function F(s) is 1 in a frequency band lower than or equal to the frequency fa lower than the third cutoff frequency Cf3. In a frequency band higher than the frequency fa, the gain of the transfer function F(s) decreases as the frequency f increases.

In at least a part of the second frequency band FB2, the gain of the transfer function F(s) of the corrector 290 increases as the frequency f decreases. In the present example embodiment, in the entire second frequency band FB2, the gain of the transfer function F(s) of the corrector 290 increases as the frequency f decreases. In other words, in the entire second frequency band FB2, the gain of the transfer function F(s) of the corrector 290 decreases as the frequency f increases.

The second correction torque T_{f2} is generated by multiplying the steering torque Tₕ by the gain of the transfer function F(s) of the corrector 290. Since the gain of the transfer function F(s) is substantially 1, the component of the first frequency band FB1 in the second correction torque T_{f2} has substantially the same value as the component of the first frequency band FB1 in the steering torque Tₕ. Since the gain of the transfer function F(s) is smaller than the first frequency band FB1, the component of the second frequency band FB2 in the second correction torque T_{f2} has a value lower than that of the component of the second frequency band FB2 in the steering torque Tₕ. The component of the second frequency band FB2 in the second correction torque T_{f2} becomes smaller than the component of the second frequency band FB2 in the steering torque Tₕ as the frequency f increases.

As illustrated in FIG. 3, the second correction torque T_{f2} is subtracted from the input torque Tᵣ from which the first correction torque T_{f1} has been subtracted in the subtractor SU4. The input torque Tᵣ from which the second correction torque T_{f2} has been subtracted is input to the control target 560 after the adder AD1 adds the state compensation value Vₛ and the adder AD2 adds the disturbance torque T_{d}. That is, the second correction torque T_{f2} is subtracted from the input torque Tᵣ after being corrected by the first correction torque T_{f1} and before being input to the control target 560. The input torque Tᵣ in a state in which the first correction torque T_{f1} and the second correction torque T_{f2} are subtracted is input to the control target 560.

Next, control by the model following controller 230 will be described in more detail. The model following controller 230 controls the control target 560 using the inverse model of the nominal model as the internal model, that is, the inverse nominal model 231. In the present example embodiment, a torque ripple or the like depending on the angular velocity ω of the motor 543 can be compensated by a feedback loop formed by the model following controller 230.

The model following controller 230 is structurally similar to a conventional disturbance estimator (disturbance observer), but has different actions and effects. A conventional disturbance estimator estimates a disturbance torque by using an inverse plant model as an internal model as a model close to the control target 560, and reduces the influence of disturbance by adjusting the disturbance torque in advance.

The control by the model following controller 230 according to the present example embodiment utilizes the effect that the transfer function P(s) of the control target 560 is constrained to the transfer function Pₙ(s) of the nominal model as the internal model, by the feedback loop. For example, if the nominal model is defined such that there is no torque ripple, the transfer function P(s) of the control target 560 is constrained to the characteristic without the torque ripple by the model following control, and as a result, the torque ripple can be reduced by applying torque ripple compensation. By setting the nominal model as a low-inertia model and constraining the control target 560 with the nominal model, the control target 560 can be treated as a low-inertia model. The control target 560 can be treated as a low viscosity model by setting the nominal model as a low viscosity model and constraining the control target 560 with the nominal model. By the model following controller 230 executing model following control, for example, lost torque compensation or motor inertia compensation is performed in addition to compensation of the torque ripple of the motor 543. By appropriately setting Jₙ and Bₙ in Expressions (4) and (5) described above, a desired frequency characteristic can be given to the transfer function P(s) of the control target 560.

When a modeling error between the transfer function P(s) of the control target 560 and the transfer function Pₙ(s) of the nominal model is Δ(s), the transfer function P(s) of the control target 560 is expressed by the following Expression (6).

$$\begin{matrix}Expression 6 & \\ P ( s ) = \frac{1}{{J}_{n} {s}^{2} + {B}_{{n}^{S}}} ( 1 + Δ ( s ) ) & ( 6 )\end{matrix}$$

The gain characteristic of the transfer function P(s) of the control target 560 has peaks in two frequency values, for example. The modeling error Δ(s) appears, for example, near the higher frequency peak of the two peaks in the gain characteristic of the control target 560. Therefore, as illustrated in FIG. 4, the reciprocal 1/Δ(s) of the modeling error Δ(s) has a bottom in a relatively high frequency region. In FIG. 4, the modeling error Δ(s) is indicated by an absolute value. When the modeling error Δ(s) increases, the deviation between the transfer function P(s) of the control target 560 and the transfer function Pₙ(s) of the nominal model increases, and the control of the control target 560 using the nominal model by the model following controller 230 becomes unstable. For this reason, in a domain where the modeling error Δ(s) is relatively small, the control target 560 can be stably and suitably controlled by setting the gain of the complementary sensitivity function T(s) to be substantially 1 and constraining the control target 560 to the nominal model. The frequency characteristic of the modeling error Δ(s) can be adjusted by adjusting Jₙ and Bₙ in the transfer function Pₙ(s) of the nominal model. The frequency band where the gain of the complementary sensitivity function T(s) becomes substantially 1 can be adjusted by adjusting the first cutoff frequency Cf1 and the second cutoff frequency Cf2. Consequently, the gain of the complementary sensitivity function T(s) can be adjusted to be substantially 1 in the frequency band where the modeling error Δ(s) is small.

In FIG. 4, 1/Δ(s) is relatively high in a frequency band equal to or lower than the second cutoff frequency Cf2, and rapidly decreases in a frequency band higher than the second cutoff frequency Cf2. The model following control for constraining the control target 560 to the nominal model can be stably performed, for example, in a range where 1/Δ(s) is larger than 1, that is, in a range where 1/Δ(s) is larger than 0 dB. For this reason, as illustrated in FIG. 4, by adjusting 1/Δ(s) to be larger than 1 in a frequency band in which a gain of the complementary sensitivity function T(s) is substantially 1, in the case where a gain of the complementary sensitivity function T(s) is substantially 1, the control target 560 can be constrained to the nominal model to be stably and suitably controlled.

For example, in order to expand a frequency band where the control target 560 can be stably and suitably controlled by constraining the control target 560 to the nominal model, the second cutoff frequency Cf2 may be increased within a range in which 1/Δ(s) is not 1 or less, that is, within a frequency band lower than a frequency at which a curve indicating 1/Δ(s) in FIG. 4 intersects the horizontal axis. However, if the second cutoff frequency Cf2 is made too high, the gain of the complementary sensitivity function T(s) remains relatively high even though 1/Δ(s) becomes low in a frequency band higher than the second cutoff frequency Cf2, and control may become unstable. On the other hand, in the present example embodiment, since the order of the second filter 232b, which is a low-pass filter, is set to third order or more, the gain of the complementary sensitivity function T(s) can be steeply decreased in a region where the frequency is higher than the second cutoff frequency Cf2. As a result, if the second cutoff frequency Cf2 is made relatively high, the gain of the complementary sensitivity function T(s) can be immediately lowered in a frequency band higher than the second cutoff frequency Cf2, so that control of the control target 560 can be prevented from becoming unstable.

Robust stability of the model following controller 230 is guaranteed when the small-gain theorem shown in Expression (7) below is established between the complementary sensitivity function T(s) and the modeling error Δ(s).

$$\begin{matrix}Expression 7 & \\ or , ) \vert < \frac{1}{\vert Δ ( j ω ) \vert} , , \vert T ( j ω ) Δ ( j ω ) \vert < 1 , ∀ s = j ω & ( 7 )\end{matrix}$$

As described above, in order to perform model following control using the nominal model in the model following controller 230, the complementary sensitivity gain GT of the complementary sensitivity function T(s) may be substantially 1, but in consideration of robust stability, it is necessary to satisfy Expression (7) above. As understood from this, it is not possible to achieve both setting of the complementary sensitivity gain GT to substantially 1 in all frequency bands and Expression (7), and it is not possible to achieve both reduction in disturbance or the like by the model following controller 230 and robust stability.

As illustrated in FIG. 4, the complementary sensitivity gain GT of the complementary sensitivity function T(s) is smaller than 1 also in a low frequency domain FA1 where the frequency f is lower than the first cutoff frequency Cf1. In a region where the complementary sensitivity gain GT of the complementary sensitivity function T(s) is smaller than 1, the assist controller 210 controls the input torque Tᵣ to control the control target 560. In a high frequency domain FA2 where the frequency is higher than the second cutoff frequency Cf2, the complementary sensitivity gain GT of the complementary sensitivity function T(s) is greatly lowered, and the first correction torque T_{f1} from the model following controller 230 is hardly fed back to the input of the control target 560. On the other hand, in the low frequency domain FA1, the complementary sensitivity gain GT of the complementary sensitivity function T(s) is set to a certain magnitude, and the first correction torque T_{f1} is fed back to the input of the control target 560. In the low frequency domain FA1, a compensation value generated in the assist adjustment unit 270 described above is fed back to the input of the control target 560 according to the complementary sensitivity gain GT of the complementary sensitivity function T(s).

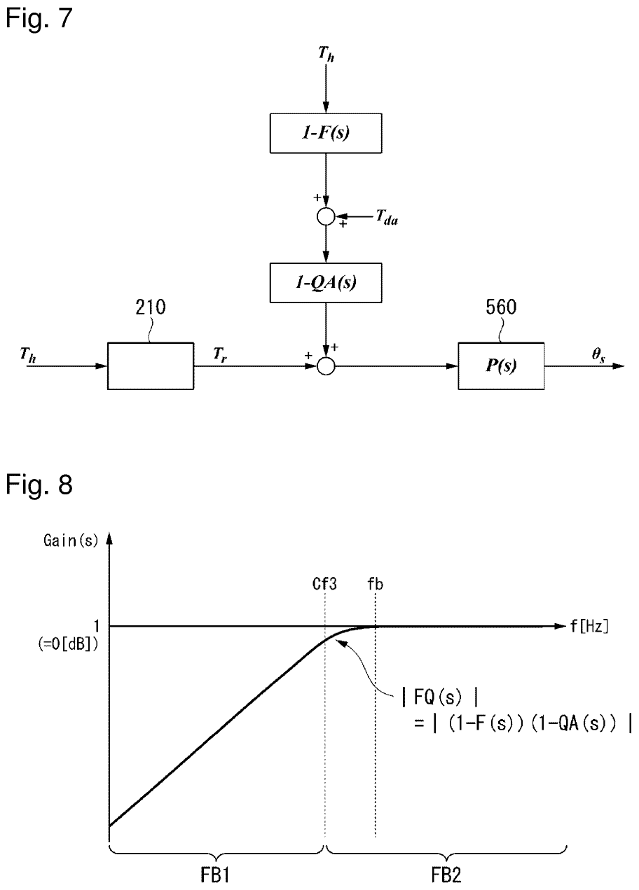

When the disturbance torque is accurately estimated by the model following control performed by the model following controller 230, the control device 100 can be simply represented as in the block diagram illustrated in FIG. 7. QA(s) illustrated in FIG. 7 is a transfer function of the filter unit 233 illustrated in FIG. 3. The filter unit 233 is a part of the model following controller 230. In the present example embodiment, the filter unit 233 includes the first filter 232a, the second filter 232b, the assist adjustment unit 270, and the adder AD3. In the simple block diagram illustrated in FIG. 7, the steering torque Tₕ input to the control target 560 as a disturbance is multiplied by a transfer function represented by (1−F(s)) (1−QΔ(s)) and then added to the input torque Tᵣ. In the simple block diagram illustrated in FIG. 7, the torque T_{da} which is a part of the disturbance torque T_{d} is multiplied by a transfer function represented by (1−QΔ(s)) and then added to the input torque Tᵣ.

The transfer function represented by (1−F(s)) (1−QA(s)) has, for example, a gain characteristic illustrated in the graph of FIG. 8. In the graph of FIG. 8, the horizontal axis represents the frequency f [Hz], and the vertical axis represents the gain of the transfer function represented by (1−F(s)) (1−QA(s)). In the following description, the transfer function represented by (1−F(s)) (1−QA(s)) is referred to as a transfer function FQ(s). As illustrated in FIG. 8, the gain of the transfer function FQ(s) in the first frequency band FB1 lower than or equal to the third cutoff frequency Cf3 is smaller than the gain of the transfer function FQ(s) in the second frequency band FB2 higher than the third cutoff frequency Cf3.

The gain of the transfer function FQ(s) is substantially 1 in the second frequency band FB2. “The gain of the transfer function FQ(s) is substantially 1” includes the case where the gain of the transfer function FQ(s) is equal to or greater than the value of the gain of the transfer function FQ(s) at the third cutoff frequency Cf3, in addition to the case where the gain of the transfer function FQ(s) is 1. The gain of the transfer function FQ(s) at the third cutoff frequency Cf3 is smaller than 1. The gain of the transfer function FQ(s) at the third cutoff frequency Cf3 is, for example, 1/√2. The gain of the transfer function FQ(s) is 1 in a frequency band equal to or higher than the frequency fb higher than the third cutoff frequency Cf3. Strictly speaking, in the frequency band of the frequency fb or higher, the gain of the transfer function FQ(s) decreases as the frequency f decreases, but can be regarded as substantially 1. In a frequency band lower than the frequency fb, the gain of the transfer function FQ(s) decreases as the frequency f decreases.

In at least a part of the first frequency band FB1, the gain of the transfer function FQ(s) increases as the frequency f increases. In the present example embodiment, in the entire first frequency band FB1, the gain of the transfer function FQ(s) increases as the frequency f increases. In other words, in the entire first frequency band FB1, the gain of the transfer function FQ(s) decreases as the frequency f decreases.

In the block diagram of FIG. 7, since the disturbance is accurately estimated by the model following control, in the frequency band in which the gain of the transfer function FQ(s) is 1, the frequency component of the steering torque Tₕ in the frequency band is compensated by 100%. For example, in a frequency band in which the gain of the transfer function FQ(s) is 0.5, half of the frequency component of the steering torque Tₕ in the frequency band is compensated.

Here, when the steering torque Tₕ is compensated by 100% by the model following control, the torque ripple generated in the steering torque Tₕ is compensated, and the torque transmitted from the road surface on which the vehicle travels to the steering person as the steering torque Tₕ is also compensated. Therefore, there is a problem that it is difficult for the steering person to feel the state of the road surface from the steering wheel 521. Therefore, there is a problem that the steering feeling felt by the steering person decreases.

In view of the above problem, according to the present example embodiment, the control device 100 includes the corrector 290 that receives the steering torque Tₕ as an input and outputs the second correction torque T_{f2} to correct the input torque Tᵣ. The input torque Tᵣ in a state in which the first correction torque T_{f1} and the second correction torque T_{f2} are subtracted is input to the control target 560. The gain of the transfer function F(s) of the corrector 290 in the first frequency band FB1 equal to or lower than the third cutoff frequency Cf3 that is a predetermined frequency is larger than the gain of the transfer function F(s) of the corrector 290 in the second frequency band FB2 higher than the third cutoff frequency Cf3. In other words, the control method of controlling the control target 560 includes outputting the second correction torque T_{f2} to correct the input torque Tᵣ using the steering torque Tₕ as an input, inputting the input torque Tᵣ in a state where the first correction torque T_{f1} and the second correction torque T_{f2} are subtracted, to the control target 560, and allowing the gain of the transfer function F(s) from the steering torque Tₕ to the second correction torque T_{f2} in the first frequency band FB1 to be larger than the gain of the transfer function F(s) in the second frequency band FB2. Therefore, in the first frequency band FB1 lower than the second frequency band FB2, the value of the frequency component of the generated second correction torque T_{f2} is easily set to the same value as or close to the value of the frequency component of the steering torque Tₕ. The frequency of the torque or the like received from the road surface, which is preferably transmitted to the steering person via the steering wheel 521, is lower than the frequency of the torque ripple generated in the steering torque Tₕ. Therefore, in the first frequency band FB1 lower than the second frequency band FB2, the frequency component of the second correction torque T_{f2} is set to a value equal to or close to the frequency component of the steering torque Tₕ, and the second correction torque T_{f2} is subtracted from the input torque Tᵣ, so that the frequency component of the steering torque Tₕ that is preferably transmitted to the steering person can be subtracted from the input torque Tᵣ. As a result, it is possible to reduce at least a part of the frequency component of the steering torque Tₕ that is preferably transmitted to the steering person, from the disturbance input to the control target 560, and it is possible to suppress the frequency component of the steering torque Tₕ that is preferably transmitted to the steering person from being compensated by the model following control. Therefore, the frequency component of the steering torque Tₕ that is preferably transmitted to the steering person can be easily transmitted to the steering person via the steering wheel 521. Therefore, the steering person can feel the state of the road surface by the steering torque Tₕ received from the steering wheel 521, and it is possible to suppress a decrease in the steering feeling felt by the steering person. On the other hand, in the second frequency band FB2 higher than the first frequency band FB1, since the gain of the transfer function F(s) of the corrector 290 is smaller than the first frequency band FB1, the value of the frequency component of the generated second correction torque T_{f2} can be made smaller than the frequency component of the steering torque Tₕ. As a result, even if the second correction torque T_{f2} is subtracted from the input torque Tᵣ, a component of a torque ripple having a relatively high frequency in the steering torque Tₕ can be left as disturbance applied to the control target 560. Therefore, the component of the torque ripple having a relatively high frequency in the steering torque Tₕ can be compensated by the model following control, and the transmission to the steering person is suppressed. Therefore, it is possible to suppress transmission of unnecessary vibration or the like to the steering person, and it is possible to further suppress deterioration of the steering feeling felt by the steering person.

The frequency f of the torque ripple generated in the steering torque Tₕ is higher than 15 Hz, for example. The frequency f of the torque that is preferably transmitted to the steering person, such as the torque transmitted to the steering person as the steering torque Tₕ from the road surface on which the vehicle travels, is, for example, about 5 Hz to 15 Hz inclusive.

According to the present example embodiment, in at least a part of the second frequency band FB2, the gain of the transfer function F(s) of the corrector 290 increases as the frequency f decreases. In other words, the control method for the control target 560 includes increasing the gain of the transfer function F(s) from the steering torque Tₕ to the second correction torque T_{f2} in at least a part of the second frequency band FB2, as the frequency f decreases. Therefore, in at least a part of the second frequency band FB2, the second correction torque T_{f2} can be increased as the frequency f decreases. As a result, the second correction torque T_{f2} can be easily increased to some extent in a relatively low frequency band of the second frequency band FB2. Therefore, it is possible to transmit a frequency component in a frequency band that is somewhat lower among the frequency components of the steering torque Tₕ in the second frequency band FB2, to the steering person with a certain magnitude. Therefore, as compared with the case where the entire frequency component of the steering torque Tₕ is not transmitted to the steering person in the entire second frequency band FB2, it is possible to suppress generation of discomfort in the steering feeling felt by the steering person, and it is possible to further suppress the deterioration in the steering feeling felt by the steering person.

According to the present example embodiment, the second correction torque T_{f2} is subtracted from the input torque Tᵣ after being corrected by the first correction torque T_{f1} and before being input to the control target 560. The output of the control target 560 and the input torque Tᵣ after the first correction torque T_{f1} is subtracted and before the second correction torque T_{f2} is subtracted are input to the model following controller 230. In other words, the method of controlling the control target 560 includes subtracting the second correction torque T_{f2} from the input torque Tᵣ after being corrected by the first correction torque T_{f1} and before being input to the control target 560, and executing the model following control based on the output of the control target 560 and the input torque Tᵣ after the first correction torque T_{f1} is subtracted and before the second correction torque T_{f2} is subtracted. By subtracting the second correction torque T_{f2} from the input torque Tᵣ in this manner, the steering torque Tₕ can be prevented from being compensated by the model following control by the amount of the second correction torque T_{f2}. Therefore, the second correction torque T_{f2} can be suitably transmitted to the steering person, and it is possible to further suppress a decrease in the steering feeling felt by the steering person.

According to the present example embodiment, the corrector 290 performs low-pass filter processing on the steering torque Tₕ to generate the second correction torque T_{f2}. In other words, the method of controlling the control target 560 includes performing low-pass filter processing on the steering torque Tₕ to generate the second correction torque T_{f2}. Therefore, the second correction torque T_{f2} having a large frequency component in the first frequency band FB1 and a small frequency component in the second frequency band FB2 can be easily generated based on the steering torque Tₕ.

In the present example embodiment, the frequency characteristic of the steering torque Tₕ compensated by the model following control is set to a frequency characteristic having a waveform similar to the waveform of the transfer function FQ(s) illustrated in FIG. 8 by adjusting the transfer function F(s). As a result, the torque ripple included in the steering torque Tₕ can be suitably compensated by the model following control while suppressing a decrease in the steering feeling of the steering person.

At least a part of the function of each component of the control device 100 described above may be implemented by hardware including a circuit unit such as a large scale integration (LSI), an application specific integrated circuit (ASIC), a field-programmable gate array (FPGA), and a graphics processing unit (GPU), or may be implemented by cooperation of software and hardware. A storage unit in which a program for causing the processor 200 of the control device 100, which is a computer, to execute the above-described control method is stored is realized by, for example, a storage medium such as a random access memory (RAM), a read only memory (ROM), a hard disk drive (HDD), or a flash memory. The storage unit is not particularly limited as long as a program for causing a computer to execute the above-described control method can be stored, and may be a microcomputer or a disk medium such as a CD-ROM. The storage unit may be provided separately from the control device 100. In this case, the control device 100 may communicate with the storage unit by wired communication or wireless communication and execute the program stored in the storage unit.

The present disclosure is not limited to the above-described example embodiment, and other configurations and other methods can be employed within the scope of the technical idea of the present disclosure. The gain of the transfer function of the corrector may have any frequency characteristic as long as the gain is larger in the first frequency band than in the second frequency band. The gain of the transfer function of the corrector may increase as the frequency decreases only in a portion of the second frequency band. In this case, the gain of the transfer function of the corrector in the other portion of the second frequency band may be constant, for example, or may decrease as the frequency decreases. The corrector may generate the second correction torque in any manner as long as the second correction torque is output in response to an input of the torsion bar torque (steering torque).

Note that example embodiments of the present disclosure can have any of the configurations as described below.

[1] A control device that controls, as a control target, a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft, the control device including an assist controller configured or programmed to generate an input torque to be input to the control target based on a torsion bar torque generated in the torsion bar, a model following controller configured or programmed to generate a first correction torque to correct the input torque based on a nominal model based on a configuration of the control target, and a corrector configured or programmed to receive the torsion bar torque as an input and output a second correction torque to correct the input torque. The model following controller is configured or programmed such that a transfer function of the control target is constrained to a transfer function of the nominal model in a frequency band in which a complementary sensitivity gain is 1 or substantially 1, the complementary sensitivity gain being a gain in a gain characteristic of a complementary sensitivity function with respect to a modeling error between the control target and the nominal model. The input torque in a state in which the first correction torque and the second correction torque are subtracted is input to the control target, and a gain of a transfer function of the corrector in a first frequency band that is equal to or lower than a predetermined frequency is larger than a gain of the transfer function of the corrector in a second frequency band that is higher than the predetermined frequency.

[2] The control device according to [1], wherein in at least a portion of the second frequency band, the gain of the transfer function of the corrector increases as the frequency decreases.

[3] The control device according to [1] or [2], wherein the second correction torque is subtracted from the input torque after being corrected by the first correction torque and before being input to the control target, and an output of the control target and the input torque after the first correction torque is subtracted and before the second correction torque is subtracted are input to the model following controller.

[4] The control device according to any one of [1] to [3], wherein the corrector is configured or programmed to perform low-pass filter processing on the torsion bar torque to generate the second correction torque.

[5] A motor device including the control device according to any one of [1] to [4] and the motor.

[6] An electric power steering device including the motor device according to [5] and a steering assembly including the input shaft, the output shaft, and the torsion bar.

[7] A control method of controlling, as a control target, a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft, the control method including generating an input torque to be input to the control target based on a torsion bar torque generated in the torsion bar, executing a model following control to generate a first correction torque to correct the input torque based on a nominal model based on a configuration of the control target, constraining a transfer function of the control target to a transfer function of the nominal model in a frequency band in which a complementary sensitivity gain is 1 or substantially 1 by the model following control, the complementary sensitivity gain being a gain in a gain characteristic of a complementary sensitivity function with respect to a modeling error between the control target and the nominal model, receiving the torsion bar torque as an input and outputting a second correction torque to correct the input torque, inputting, to the control target, the input torque in a state in which the first correction torque and the second correction torque are subtracted; and increasing a gain of a transfer function from the torsion bar torque to the second correction torque in a first frequency band that is equal to or lower than a predetermined frequency to be larger than a gain of the transfer function from the torsion bar torque to the second correction torque in a second frequency band that is higher than the predetermined frequency.

[8] The control method according to [7], further including in at least a portion of the second frequency band, increasing the gain of the transfer function from the torsion bar torque to the second correction torque as the frequency decreases.

[9] The control method according to [7] or [8], further including subtracting the second correction torque from the input torque after being corrected by the first correction torque and before being input to the control target, and executing the model following control based on an output of the control target and the input torque after the first correction torque is subtracted and before the second correction torque is subtracted.

[10] The control method according to any one of [7] to [9], further including performing low-pass filter processing on the torsion bar torque to generate the second correction torque.

[11] A non-transitory computer readable medium containing a program executable to cause a computer to execute the control method according to any one of [7] to [10].

The configurations and methods described above in the present description can be appropriately combined within a range consistent with each other.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A control device that controls, as a control target, a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft, the control device comprising:
an assist controller configured or programmed to generate an input torque to be input to the control target based on a torsion bar torque generated in the torsion bar;
a model following controller configured or programmed to generate a first correction torque to correct the input torque based on a nominal model based on a configuration of the control target; and
a corrector configured or programmed to receive the torsion bar torque as an input and outputs a second correction torque to correct the input torque; wherein
the model following controller is configured or programmed such that a transfer function of the control target is constrained to a transfer function of the nominal model in a frequency band in which a complementary sensitivity gain is 1 or substantially 1, the complementary sensitivity gain being a gain in a gain characteristic of a complementary sensitivity function with respect to a modeling error between the control target and the nominal model;
the input torque in a state in which the first correction torque and the second correction torque are subtracted is input to the control target; and
a gain of a transfer function of the corrector in a first frequency band that is equal to or lower than a predetermined frequency is larger than a gain of the transfer function of the corrector in a second frequency band that is higher than the predetermined frequency.

2. The control device according to claim 1, wherein in at least a portion of the second frequency band, the gain of the transfer function of the corrector increases as the frequency decreases.

3. The control device according to claim 1, wherein
the second correction torque is subtracted from the input torque after being corrected by the first correction torque and before being input to the control target; and
an output of the control target and the input torque after the first correction torque is subtracted and before the second correction torque is subtracted are input to the model following controller.

4. The control device according to claim 1, wherein the corrector is configured or programmed to perform low-pass filter processing on the torsion bar torque to generate the second correction torque.

5. A motor device comprising:
the control device according to claim 1; and
the motor.

6. An electric power steering device comprising:
the motor device according to claim 5; and
a steering assembly including the input shaft, the output shaft, and the torsion bar.

7. A control method of controlling, as a control target, a portion including a motor of an electric power steering device mounted on a vehicle, the electric power steering device including an input shaft to which a steering wheel to be steered by a steering person is connected, an output shaft connected to the input shaft via a torsion bar, and the motor connected to the output shaft, the control method comprising:
generating an input torque to be input to the control target based on a torsion bar torque generated in the torsion bar;
executing a model following control to generate a first correction torque to correct the input torque based on a nominal model based on a configuration of the control target;
constraining a transfer function of the control target to a transfer function of the nominal model in a frequency band in which a complementary sensitivity gain is 1 or substantially 1 by the model following control, the complementary sensitivity gain being a gain in a gain characteristic of a complementary sensitivity function with respect to a modeling error between the control target and the nominal model;
receiving the torsion bar torque as an input and outputting a second correction torque to correct the input torque;
inputting, to the control target, the input torque in a state in which the first correction torque and the second correction torque are subtracted; and
increasing a gain of a transfer function from the torsion bar torque to the second correction torque in a first frequency band that is equal to or lower than a predetermined frequency to be larger than a gain of the transfer function from the torsion bar torque to the second correction torque in a second frequency band that is higher than the predetermined frequency.
